(19) United States
(12) Patent Application Publication
(10) Pub. No.: US 2009/0187569 A1
(43) Pub. Date: Jul. 23, 2009

(54) SYSTEM AND METHOD FOR A WEB- BASED PEOPLE PICTURE DIRECTORY

(75) Inventors: DAN LUBARSKI, WATERTOWN, MA (US); SERGEY PORFIRIEV, NEWTON, MA (US); SERGEY PRAZDNICHKOV, MOSCOW (RU)

Correspondence Address: AKC PATENTS, 215 GROVE ST., NEWTON, MA, 02466, US

(73) Assignee: HUMANBOOK, INC., WELLESLEY HILLS, MA (US)

(21) Appl. No.: 12/353,311

(22) Filed: Jan. 14, 2009

Related U.S. Application Data
(63) Continuation of application No. 12/342,783, filed on Dec. 23, 2008.
(60) Provisional application No. 61/022,633, filed on Jan. 22, 2008.

(51) Int. Cl. G06F 17/30

(52) U.S. Cl. 707/6; 707/E17.039

(57) ABSTRACT

An online system and a method for a web-based people picture directory provides collaborative identification of people pictured in the directory. The method includes creating profile templates for each person on earth and storing these profile templates in a central database. Next, populating the profile templates with publicly available basic information and publishing the public profile information in the web-based people picture directory. Next, retrieving a first person's own profile template, uploading the first person's personal pictures and identifying and tagging images of other persons depicted in the first person's personal pictures. Next, cross-correlating and matching the identified images of the other persons depicted in the first person's uploaded personal pictures with profile templates corresponding to the other persons and when there is a match uploading the first person's pictures depicting the identified persons' images into the corresponding profile templates of the depicted persons.

### CROSS REFERENCE TO RELATED CO-PENDING APPLICATIONS

This application claims the benefit of U.S. provisional application Ser. No. 61/022.633 filed on Jan. 22, 2008 and entitled SYSTEM AND METHOD FOR SYSTEM AND METHOD FOR A WEB-BASED PEOPLE PICTURE DIRECTORY which is commonly assigned and the contents of which are expressly incorporated herein by reference.

This application is also related to and claims the benefit of co-pending U.S. application Ser. No. 12/342,783 filed on Dec. 23, 2008 and entitled SYSTEM AND METHOD FOR A WEB-BASED PEOPLE DIRECTORY which is commonly assigned and the contents of which are expressly incorporated herein by reference.

This application is also related to and claims the benefit of co-pending U.S. application Ser. No. 12/342,932 filed on Dec. 23, 2008 and entitled SYSTEM AND METHOD FOR A WEB-BASED ADDRESS BOOK which is commonly assigned and the contents of which are expressly incorporated herein by reference.

This application is also related to and claims the benefit of co-pending U.S. application Ser. No. 12/343,117 filed on Dec. 23, 2008 and entitled SYSTEM AND METHOD FOR A WEB-BASED NETWORKING DATABASE which is commonly assigned and the contents of which are expressly incorporated herein by reference.

### FIELD OF THE INVENTION

The present invention relates to a system and a method for a web-based people picture directory, and in particular to an online people picture directory that allows collaborative identification of people pictured in the directory.

### BACKGROUND OF THE INVENTION

In the physical world, a person is usually identified by comparing the physical image of the person with a picture in an identification document (ID) or by being recognized by another person. In the virtual community of the World Wide Web (www) people are identified in their online communications with other people via a unique electronic address or by using a user name and a password. Searching for information about a person online involves accessing an online directory service and entering the name of the person in predetermined search fields 61, 62, as shown in FIG. 1. Examples of such online people directory searching services include intelius.com, peopleLookup.com, whitepages.com, anywho.com, switchboard.com, or people.yahoo.com, among others. The search results are usually displayed in a new webpage 70, and may include, the person's name 64, phone number 66, address 67, and/or e-mail information, as shown in FIG. 2. However, since humans are used to recognize a person based on his physical image it is desirable to associate a picture with the profile of the searched person.

Several social network groups such as www.facebook.com, www.linkedin.com and online alumni network of people who attended a specific college or university include pictures with the published personal profiles of their members. For each group member a profile is created and stored in a database. A group member accesses his profile by login into the group's website via a user identification and password and enters and/or modifies his profile information content. Access to the user's profile by other network members is controlled by the user. These prior art systems rely upon each group member actively managing and updating his online profile content and social networking information. However, this usually does not happen. Therefore the retrieved profile information may be wrong, outdated and in general not reliable. The people depicted in the pictures are usually not identified or the identification is not correct. Furthermore, there is no way for correcting the published information by anyone else but the member and the information is only available to the members of a specific group.

Accordingly, there is a need for a web-based people picture directory that is publicly available and provides reliable image-based identification of a person.

### SUMMARY OF THE INVENTION

In general, in one aspect, the invention features a computer implemented method for an online people picture directory including the following. First, generating a profile template for each person within a group and storing them in a central database and then populating each person's profile template with publicly available information. Next, publishing each person's profile template through a web-based people picture directory application executing on a first computing device. The web-based people picture directory application is accessed by a first person of the group through a browser executing on a second computing device. The second computing device is adapted to connect to the first computing device via a network connection. Next, providing a first webpage adapted to be viewed by the first person via the browser for the first person to login into the web-based people picture directory application and to search the first person's own profile template in the central database. Next, retrieving the first person's own profile template and displaying it in a second webpage adapted to be viewed by the first person through the browser. Next, uploading the first person's personal pictures and identifying and tagging images of other persons depicted in the first person's personal pictures. Next, cross-correlating and matching the identified images of the other persons depicted in the first person's uploaded personal pictures with profile templates corresponding to the other persons and when there is a match uploading the first person's pictures depicting the identified persons' images into the corresponding profile templates of the depicted persons.

Implementations of this aspect of the invention may include one or more of the following features. The profile template has one or more fields including last name, first name, address, age, date of birth, phone number, e-mail address, education background, work address, personal address book, personal contacts and pictures. The method further includes selecting one or more of the fields to be publicly displayed in the profile template. The method further includes updating the first person's profile information by the first person. The method further includes displaying the updated profile template and uploaded personal pictures of the first person in the second webpage. The method further includes verifying and updating the first person's profile information by other persons of the group. The method further includes updating the personal pictures of the first person in the first person's profile template by other persons. The method further includes inviting the identified persons to join the web-based people picture directory application, verify information in their personal profile templates and then upload their personal pictures. The method further includes generating a profile template for a second person whose image was identified by the first person when none exist in the central database. The second computing device may be a computer, a mobile phone, a pager, a television remote control, a PDA or combinations thereof. The group may be a group of persons residing in a certain geographic area, a group of persons belonging to a certain organization, or a group of all persons on earth. The publicly available information may be data from telephone directories, business directories, marketing data, financial data or other legally accessible data. Each person's profile information may be verified by answering preset questions formulated based on group common knowledge. The method further includes grouping together into subgroups persons with the same field parameters. The method further includes providing communication tools for communications between the persons within the group or the subgroups. The other persons are identified by the first person, other persons in the group, a directory administrator or a face recognition program. The method also includes selecting a representative picture of a person and using it as a picture ID in the people picture directory.

In general, in another aspect, the invention features a computer system comprising a first computing device, a storage device, profile templates for each person on earth stored in a central database stored in the storage device and a web-based people picture directory application stored in the storage device. The web-based people picture directory application includes a first webpage adapted to be viewed by a first person through a browser executing on a second computing device and a second webpage. The second computing device is adapted to connect to the first computing device via a network connection. The first webpage prompts the first person to log in the web-based people picture directory application and to search the first person's own profile template stored in the central database. The second webpage displays the first person's retrieved profile template and includes means for the first person to update the first person's profile information, means for uploading the first person's personal pictures, means for identifying and tagging images of other persons depicted in the first person's personal pictures, means for cross-correlating and matching the identified images of the other persons depicted in the first person's uploaded personal pictures with profile templates corresponding to the other persons and when there is a match uploading the first person's pictures depicting the identified persons' images into the corresponding profile templates of the depicted persons.

In general, in another aspect, the invention features an interactive web-based people picture directory application stored in a first computing device and adapted to be accessed by a first person via a second computing device connecting to the first computing device via a network connection. The web-based people picture directory application includes a first webpage adapted to be viewed by the first person through a browser executing on the second computing device and a second webpage also adapted to be viewed by the first person through the browser. The first webpage prompts the first person to login into the web-based people picture directory application and to search the first person's own profile template stored in a central database. The second webpage displays the first person's profile template and includes means for the first person to update the first person's profile information, means for uploading the first person's personal pictures, means for identifying and tagging images of other persons depicted in the first person's personal pictures, means for cross-correlating and matching the identified images of the other persons depicted in the first person's uploaded personal pictures with profile templates corresponding to the other persons and when there is a match uploading the first person's pictures depicting the identified persons' images into the corresponding profile templates of the depicted persons.

In general, in another aspect, the invention features a display device including first and second graphical user interfaces. The first graphical user interface includes a first row and a control. The first row comprises a prompt to a first person to login into a web-based people picture directory application and to search the first person's own profile template stored in a central database. Actuation of the control initiates the searching and retrieval of the first person's profile template. The second graphical user interface includes one or more rows displaying the first person's retrieved profile template and additional controls. Activation of the additional controls allows the first person to update information in the first person's profile template, to upload the first person's personal pictures, to identify and tag images of other persons depicted in the first person's personal pictures, to cross-correlate and match the identified images of the other persons depicted in the first person's uploaded personal pictures with profile templates corresponding to the other persons and when there is a match to upload the first person's pictures depicting the identified persons' images into the corresponding profile templates of the depicted persons.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 depicts a prior art online directory search service;

FIG. 2 illustrates search results obtained with the online directory search service of FIG. 1;

FIG. 3 is an overview diagram of the online directory system according to this invention;

FIG. 4 is a schematic diagram of the database of FIG. 3;

FIG. 5 depicts a profile template as stored in the database;

FIG. 6 depicts the publicly available directory profile based on the profile of FIG. 5;

FIG. 7 depicts a profile template including a picture album as stored in the database; and

FIG. 8 illustrates the process of creating the collaborative web-based people picture directory of this invention.

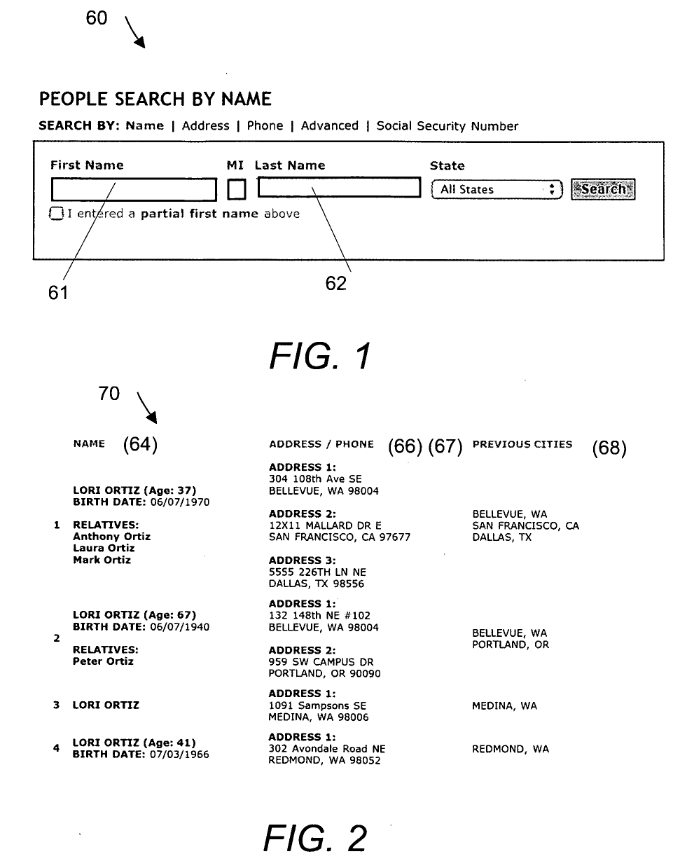

### DETAILED DESCRIPTION OF THE INVENTION

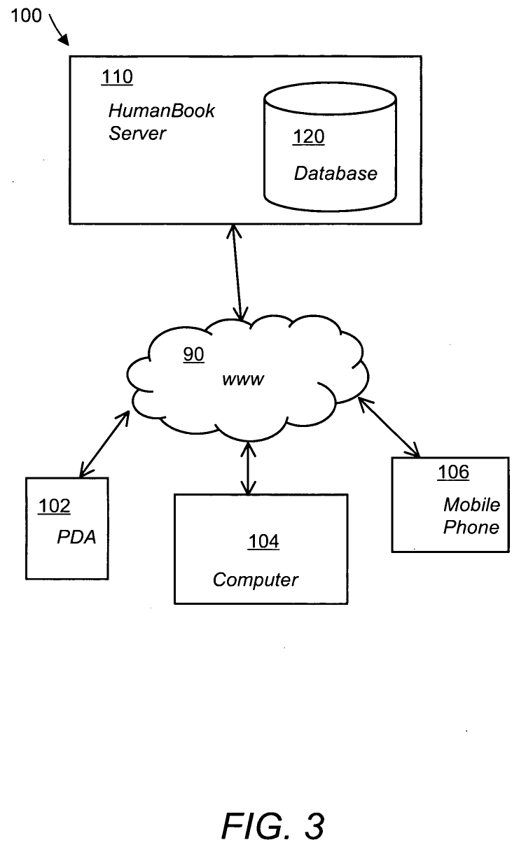

Referring to FIG. 3, a web-based people directory 100 includes a database 120, a server 110 and client communication devices 102, 104, 106. The client communication devices include a Personal Digital Assistant (PDA) 102, a computer 104, and a mobile phone 106. In other examples, the client communication devices may be wired or wirelesses devices including a pager, a wireless laptop computer, a personal computer, a television remote control, or combinations thereof. The client communication devices access the server 110 and database 120 via a network connection 90. In one example, network connection 90 is the Internet. In other examples, the network connection 90 may be a phone network, a cable network, or other wireless or a wired networks.

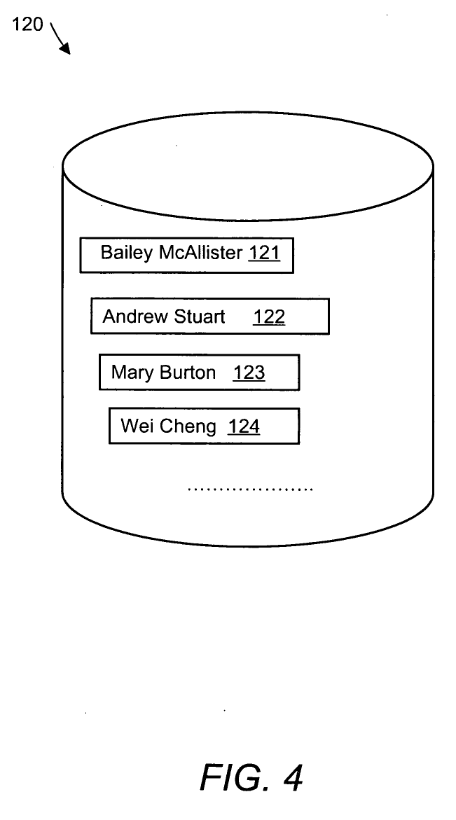

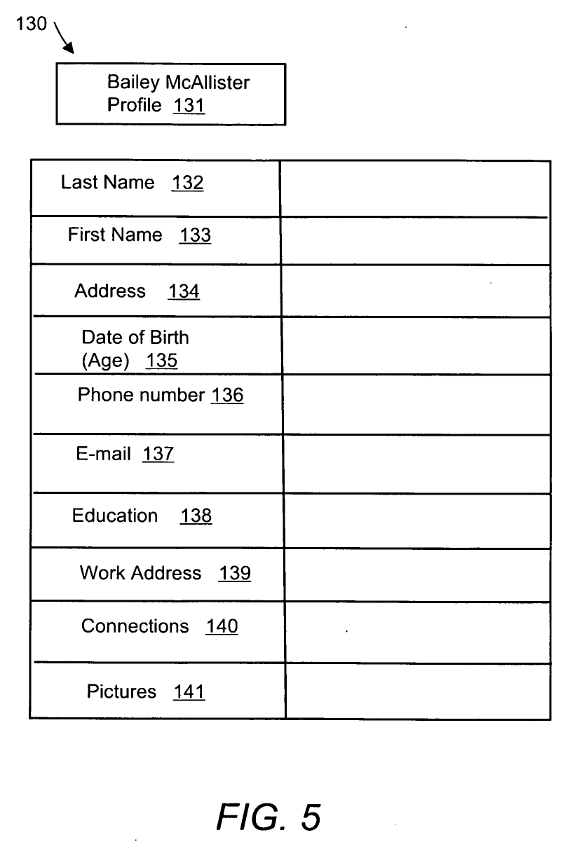

Database 120 includes personal data profiles of people. Examples of people whose profiles are listed in database 120 are people residing in a certain geographic area or people belonging to a certain organization or group, or in general all people on earth, as shown in FIG. 4. Database 120 also includes profiles of entities including businesses, educational institutions and organizations, among others. For every person or entity the system has a unique index preset and empty fields preserved for all attributes related to that person or entity. Referring to FIG. 5, the profile for Bailey McAllister 130 includes the unique preset index 131 and parameter fields for last name 132, first name 133, address 134, date of birth or age 135, phone number 136, education 138, work address 139, personal and/or business connections 140 and pictures 141, among others. Basic information for each profile is preloaded by the system administrator based on publicly available data. The basic information is defined as information sufficient for identifying and matching a specific person with a specific profile. In one example, the basic information is a name and/or any of the other mentioned parameters. Publicly available data include data from phone directories, business directories, marketing data and financial data, among others. In other examples, other legally accessible data are also included. The basic profile information is published and then other people including the person to whom the profile belongs contribute, edit and modify the profile information. This unique feature of the system allows people to share knowledge about a person and record it to preset database fields of the person's profile. The profile index and the individual profile fields have unique locations, which can be searched and easily found. The system is self updated and the information is always current because people contribute to it and edit it. Since every piece of information has a unique location—once somebody changes it, all people can see the updated information because everyone is linked to the same index field of information. This web-based people directory system is a Web 2.0 website that combines the online social network attributes with the ability to contribute content and information while allowing users to exercise control over their data. Web 2.0 websites refer to web-based communities and hosted services, which facilitate creativity, collaboration and sharing between users. A more detailed discussion of Web 2.0 websites is presented in Wikipedia, http://en.wikipedia.org/wiki/Web_{—}2, the contents of which is incorporated herewith.

The web-based people directory system 100 functions as a common memory storage that allows people to record and preserve their memories—attributes of contact information, pictures, people connections, past events and biographical facts. Because other people can record information about a person, it allows people to memorialize facts about a person and recall something that would have been forgotten, since somebody may still remember it and record it in a proper information field.

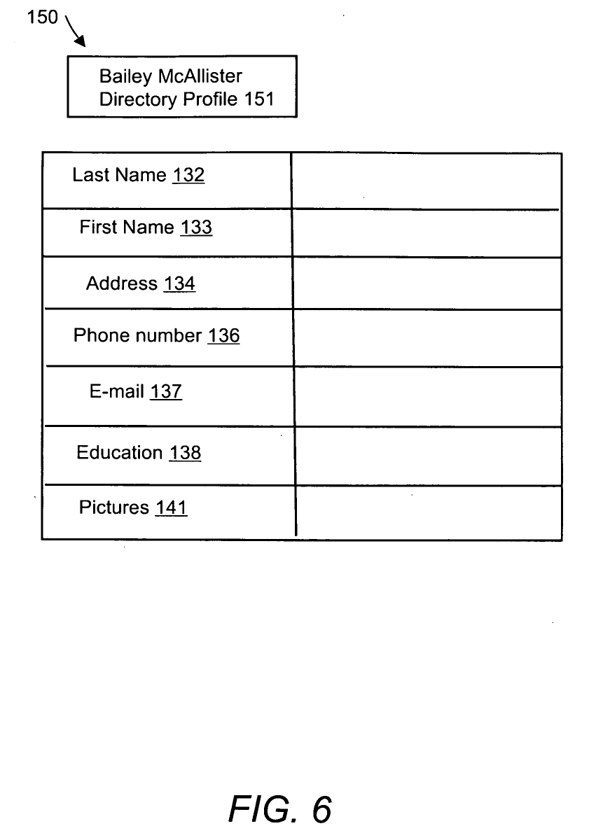

As was mentioned above, each person has control over their profile data and can turn on or off access and visibility of any particular parameter field. In the example of FIG. 6, Bailey McAllister has turned off the fields of Date of Birth 135, work address 139 and connections 140 and allowed publishing of the fields last name 132, first name 133, address 134, phone number 136, e-mail 137, education 138 and pictures 141 in the public directory profile.

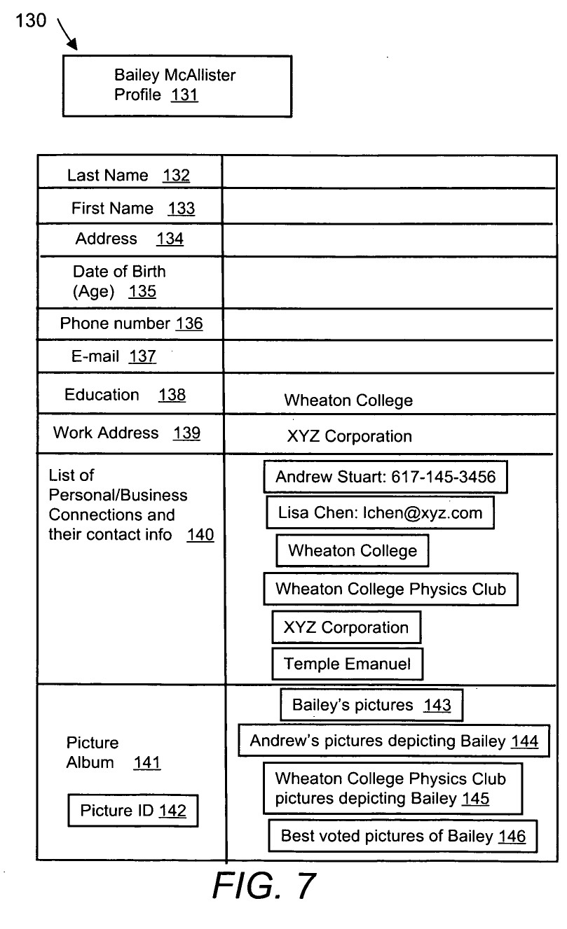

In one embodiment, users login and upload pictures 141 of themselves and/or other people to their own profile or to profiles of specific organizations. Referring to FIG. 7, Bailey McAllister uploads her pictures in her picture album 141, identifies (i.e., tags) her image and other people's images in the uploaded pictures 143 and links the identified people's images to their profiles. Andrew Stuart also uploads his pictures in his profile and identifies his image and the images of other people that are depicted in his pictures. One of the people whose image is identified by Andrew Stuart in his pictures is Bailey McAllister and Andrew links Bailey McAllister's images and pictures 144 to her profile. Bailey McAllister is also depicted in pictures shown in Wheaton College Physics Club album and the system identifies her image based on a face recognition program and the images of her published and identified by her or by Andrew Stuart and links these pictures 145 to her profile. If there is a mistake in the image that was identified and linked by the system or Andrew Stuart, Bailey McAllister or another person who knows her may correct the mistake (i.e., untag the image). The system prompts the users to respond to questions such as “Who is on the picture?” “Identify name!”. The users then respond by identifying images on the pictures by the person's real name and link them to a person's profiles. If an image is identified in a picture with the wrong name or wrong profile, another person or the person himself can correct it. In this way, a collaborative people picture directory is established, the content of which is collectively moderated. People can copy a picture or crop segments of a picture depicting them or other people they recognize and upload them into their own profile. Furthermore, users are asked to select the best representative picture of a person. The selection of the best quality picture or fragment occurs via a voting system. The best rated pictures or fragments 146 are shown on top of a person's profile. One of those best rated pictures is selected to function as the person's “Picture ID” 142 in the directory.

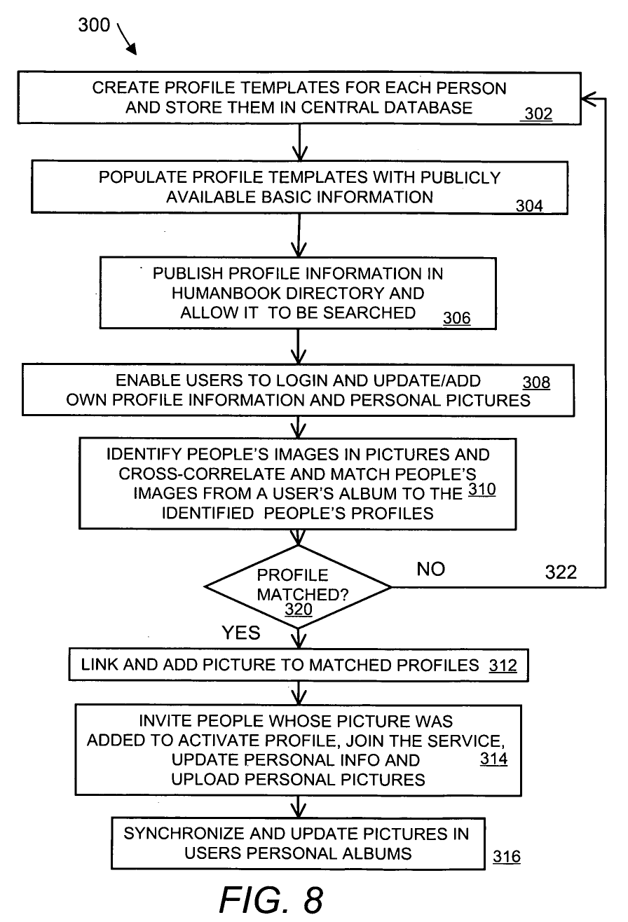

Referring to FIG. 8, the process 300 for generating the web-based people picture directory includes the following steps. First, creating profile templates for each person on earth and storing these profile templates in a central database (302). Next, populating the profile templates with publicly available basic information (304) and then publishing the public profile information in the web-based directory (306) and allowing it to be searched. Users are allowed to login into the directory website, update their own profile information and upload their personal pictures (308). Next, the images of the people in the pictures are identified and the system cross-correlates and matches images retrieved from users' albums to the identified people's profiles in the database (310). This matching of the images to a person's profile is done automatically or manually by the user, the system or the administrator. If a profile match is found (320) the picture is linked and added to the matched profile (312). The person whose image was added is invited to activate his profile, join the service, update personal profile information and upload personal pictures in his album (314). The invitation may be sent by the system administrator, the user from whose album the image was retrieved or any other user. All submissions are eponymous and can be traced back to the originator of the information. Finally the system synchronizes and updates the entered/updated pictures in all users personal address books (314). If a profile match was not found in step 320 a new profile is created and added in the database (322). The advantages of this system include the following. Once a picture is uploaded, every person depicted in the picture can be identified and linked to his profile, including those who have never visited the directory. People are identified and linked to real profiles and not to fake or made-up profiles, as is the case in prior art directories.

Furthermore, the system allows searching of the directory entries based on the various field parameters and main index and it provides accurate information easily and fast to those who need it and to those who are authorized to access it. Users with the same field parameters/attributes are matched and united in entities, groups or communities for communication purposes. The system also provides a platform and tools for communications and community group building.

In one embodiment, database 120 is used to create a central common album for people belonging to the same organization, group or entity. The central common album is created by the system administrator and stored in the server 110. This central common album is the integrator of every person's profile and albums.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for an online people picture directory comprising:
generating a profile template for each person within a group and storing them in a central database;
populating each person's profile template with publicly available information;
publishing each person's profile template through a web-based people picture directory application executing on a first computing device and wherein said web-based people picture directory application is adapted to be accessed by a first person of said group through a browser executing on a second computing device, wherein said second computing device is adapted to connect to said first computing device via a network connection;
providing a first webpage adapted to be viewed by said first person via said browser for said first person to login into said web-based people picture directory application and to search said first person's own profile template in said central database;
retrieving said first person's own profile template and displaying it in a second webpage adapted to be viewed by said first person through said browser;
uploading said first person's personal pictures into said first person's profile template and identifying and tagging images of other persons depicted in said first person's personal pictures;
cross-correlating and matching the identified images of said other persons depicted in said first person's uploaded personal pictures with profile templates corresponding to said other persons and when there is a match uploading said first person's pictures depicting said identified persons' images into said corresponding profile templates of said depicted persons.

2. The computer implemented method of claim 1 wherein said profile template comprises one or more fields comprising last name, first name, address, age, date of birth, phone number, e-mail address, education background, work address, personal address book, personal contacts and pictures.

3. The computer implemented method of claim 2 further comprising selecting one or more of said fields to be publicly displayed in said profile template.

4. The computer implemented method of claim 2 further comprising updating said first person's profile information by said first person.

5. The computer implemented method of claim 4 further comprising displaying the updated profile template and uploaded personal pictures of said first person in said second webpage.

6. The computer implemented method of claim 1 further comprising verifying and updating said first person's profile information by other persons of said group.

7. The computer implemented method of claim 5 further comprising updating said personal pictures of said first person in said first person's profile template by other persons in said group.

8. The computer implemented method of claim 1 further comprising inviting said identified persons to join said web-based people picture directory, verify information in their personal profile templates and then upload their personal pictures.

9. The computer implemented method of claim 1 further comprising generating a profile template for a second person whose image was identified by said first person when none exist in said central database.

10. The computer implemented method of claim 1 wherein said second computing device comprises one of a computer, a mobile phone, a pager, a television remote control, a PDA or combinations thereof.

11. The computer implemented method of claim 1 wherein said group comprises one of a group of persons residing in a certain geographic area, a group of persons belonging to a certain organization, or a group of all persons on earth.

12. The computer implemented method of claim 1 wherein said publicly available information comprises data from one of telephone directories, business directories, marketing data, financial data or other legally accessible data.

13. The computer implemented method of claim 1 wherein each person's profile information is verified by answering preset questions formulated based on group common knowledge.

14. The computer implemented method of claim 2 further comprising grouping together into subgroups persons with the same field parameters.

15. The computer implemented method of claim 14 further comprising providing communication tools for communications between said persons within the group or said subgroups.

16. The computer implemented method of claim 1 wherein said other persons are identified by said first person, other persons in said group, a directory administrator or a face recognition program.

17. The computer implemented method of claim 1 further comprising selecting a representative picture of a person and using it as a picture ID in said people picture directory.

18. A computer system comprising a first computing device, a storage device, profile templates for each person on earth stored in a central database stored in said storage device and a web-based people picture directory application stored in said storage device, wherein said web-based people picture directory application comprises:
a first webpage adapted to be viewed by a first person through a browser executing on a second computing device, wherein said second computing device is adapted to connect to said first computing device via a network connection, wherein said first webpage prompts said first person to login into said web-based people picture directory application and to search said first person's own profile template stored in said central database;
a second webpage displaying said first person's retrieved profile template and comprising means for said first person to update said first person's profile information, means for uploading said first person's personal pictures, means for identifying and tagging images of other persons depicted in said first person's personal pictures, means for cross-correlating and matching the identified images of said other persons depicted in said first person's uploaded personal pictures with profile templates corresponding to said other persons and when there is a match uploading said first person's pictures depicting said identified persons' images into said corresponding profile templates of said depicted persons.

19. An interactive web-based people picture directory application stored in a first computing device and adapted to be accessed by a first person via a second computing device connecting to said first computing device via a network connection comprising:
a first webpage adapted to be viewed by said first person through a browser executing on said second computing device, wherein said first webpage prompts said first person to login into said web-based people picture directory application and to search said first person's own profile template stored in a central database;
a second webpage also adapted to be viewed by said first person through said browser, wherein said second webpage displays said first person's profile template and comprises means for said first person to update said first person's profile information, means for uploading said first person's personal pictures, means for identifying and tagging images of other persons depicted in said first person's personal pictures, means for cross-correlating and matching the identified images of said other persons depicted in said first person's uploaded personal pictures with profile templates corresponding to said other persons and when there is a match uploading said first person's pictures depicting said identified persons' images into said corresponding profile templates of said depicted persons.

20. A display device comprising:
a first graphical user interface comprising a first row and a control and wherein said first row comprises a prompt to a first person to login into a web-based people picture directory application and to search said first person's own profile template stored in a central database, and wherein actuation of said control initiates said searching and retrieval of the first person's profile template;
a second graphical user interface comprising one or more rows displaying said first person's retrieved profile template and additional controls and wherein activation of said additional controls allows said first person to update information in said first person's profile template, to upload said first person's personal pictures, to identify and tag images of other persons depicted in said first person's personal pictures, to cross-correlate and match the identified images of said other persons depicted in said first person's uploaded personal pictures with profile templates corresponding to said other persons and when there is a match to upload said first person's pictures depicting said identified persons' images into said corresponding profile templates of said depicted persons.
